(19) United States
(12) Patent Application Publication
(10) Pub. No.: US 2018/0336983 A1
(43) Pub. Date: Nov. 22, 2018

(54) MIXED SOFT MAGNETIC POWDER AND DUST CORE INCLUDING THE MIXED SOFT MAGNETIC POWDER

(71) Applicant: Panasonic Intellectual Property Management Co., Ltd., Osaka (JP)

(72) Inventors: TAKAO KUROMIYA, Osaka (JP); KAZUTO FUKUDA, Osaka (JP)

(21) Appl. No.: 15/977,369

(22) Filed: May 11, 2018

(30) Foreign Application Priority Data
May 17, 2017 (JP) 2017-098093

(51) Int. Cl. H01F 1/22; H01F 41/02; B22F 3/24; B22F 5/00

(52) U.S. Cl. CPC H01F 1/22; H01F 41/0246; B22F 2301/35; B22F 5/00; B22F 2003/248; B22F 3/24

(57) ABSTRACT

A dust core having both high magnetic permeability and high withstand voltage includes a mixed soft magnetic powder containing first ellipsoidal soft magnetic particle having a smooth surface and second ellipsoidal soft magnetic particle having a rough flat surface.

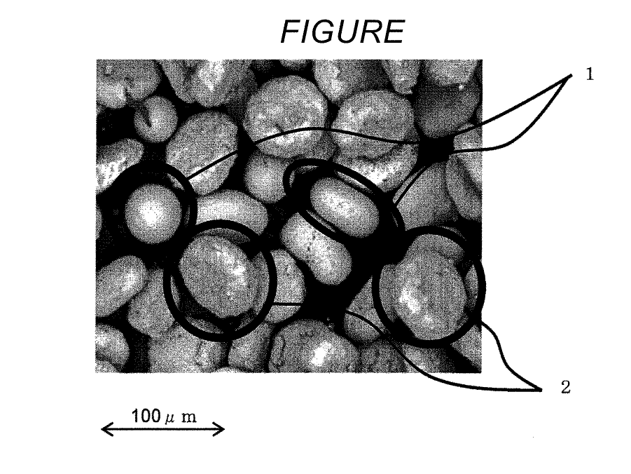

### TECHNICAL FIELD

The present disclosure relates to a mixed soft magnetic powder containing a plurality of soft magnetic particles, and to a dust core that uses such a mixed soft magnetic powder for inductor applications such as in choke coils, reactors, and transformers.

### BACKGROUND

The market for self-driving assistance systems in automobiles is expected to grow at a high rate in the near future, and there are increasing demands for cameras and sensors that sense humans and objects. The growing market for self-driving assistance systems has created a demand for size reduction and lightness in a wide range of electronic components. There is also an increasing demand for higher magnetic performance, particularly in soft magnetic dust cores used for components such as choke coils, reactors, and transformers.

### SUMMARY

A dust core requires high magnetic permeability. However, high-density packing of soft magnetic particles is required to obtain high magnetic permeability in dust cores configured from soft magnetic particles.

For example, Japanese Patent Number 4944971 describes mixing sheet-like pulverized particles and atomized spherical particles to achieve high-density packing of soft magnetic particles. High-density packing of soft magnetic particles constituting a dust core requires high-pressure molding in dust core production. However, high-pressure molding causes the soft magnetic particles to contact each other, and the withstand voltage performance decreases as a result of failed insulation between particles. Such a withstand voltage performance drop becomes particularly prominent when pressure is applied to sheet-like particles having distinct edges such as those described in the foregoing related art, because such sharp edges bite into the adjacent particles, and cause the particles to conduct electricity.

When used with spherical particles as in the foregoing related art, sheet-like particles also do not necessarily provide high packing density because the sheet-like particles align themselves along the direction of particle flow while being molded under applied pressure, and often fail to close the gaps between the spherical particles.

The present disclosure is intended to provide a solution to the foregoing problems of the related art, and it is an object of the present disclosure to provide a dust core having both high magnetic permeability and high withstand voltage.

A dust core according to an aspect of the disclosure includes a mixed soft magnetic powder that contains:

a first ellipsoidal soft magnetic particle having a surface smoothness of 1.1 to 2.0; and

a second ellipsoidal soft magnetic particle having a surface smoothness of 4.0 to 20.0, and a flattening of 3.0 to 15.0.

With the aspect of the disclosure disclosed herein, high-density packing of soft magnetic particles can be achieved while ensuring insulation between the soft magnetic particles, and a dust core can be provided that has both high magnetic permeability and high withstand voltage.

### BRIEF DESCRIPTION OF THE DRAWINGS

The FIGURE shows an electron micrograph of a mixed soft magnetic powder of first ellipsoidal soft magnetic particles and second ellipsoidal soft magnetic particles constituting a dust core according to an exemplary embodiment.

### DESCRIPTION OF EMBODIMENTS

A dust core according to a first aspect of the disclosure includes a mixed soft magnetic powder that contains:

a first soft magnetic particle of an ellipsoidal shape having a surface smoothness of 1.1 to 2.0; and

a second soft magnetic particle of an ellipsoidal shape having a surface smoothness of 4.0 to 20.0, and a flattening of 3.0 to 15.0.

A dust core according to a second aspect of the disclosure may be such that the first soft magnetic particle in the first aspect of the disclosure represents particles of which 10% to 90% are particles having a flattening of 1.2 or more.

A dust core according to a third aspect of the disclosure may be such that the first soft magnetic particle and the second soft magnetic particle in the first or second aspect of the disclosure have a mixture ratio of 1:9 to 9:1.

A dust core according to a fourth aspect of the disclosure may be such that the first soft magnetic particle and the second soft magnetic particle in any of the first to third aspects of the disclosure have a ratio D1/D2 of 0.5 to 2.0, where D1 is an average particle size of the first soft magnetic particle, and D2 is an average particle size of the second soft magnetic particle.

A dust core according to a fifth aspect of the disclosure may be such that the first soft magnetic particle and the second soft magnetic particle in any of the first to fourth aspects of the disclosure are made of same material.

A mixed soft magnetic powder according to a sixth aspect of the disclosure includes:

a first ellipsoidal soft magnetic particle having a surface smoothness of 1.1 to 2.0; and

a second ellipsoidal soft magnetic particle having a surface smoothness of 4.0 to 20.0, and a flattening of 3.0 to 15.0.

A dust core according to an embodiment is described below with reference to the accompanying drawing.

### Example Embodiment

The FIGURE shows an electron micrograph of a mixed soft magnetic powder of first ellipsoidal soft magnetic particles 1 and second ellipsoidal soft magnetic particles 2 constituting a dust core according to an exemplary embodiment.

The dust core according to this exemplary embodiment includes a mixed soft magnetic powder that contains first ellipsoidal soft magnetic particles 1 and second ellipsoidal soft magnetic particles 2. The first soft magnetic particles 1 have a surface smoothness of 1.1 to 2.0. The second soft magnetic particles 2 have a surface smoothness of 4.0 to 20.0, and a flattening of 3.0 to 15.0.

The material of the first soft magnetic particles 1 and the second soft magnetic particles 2 is not particularly limited, as long as it is a metallic material having high magnetic permeability. Examples of such metallic materials having high magnetic permeability include simple metals such as iron, cobalt, and nickel, and alloys of such metals, for example, such as permalloy, and sendust. The intended effect of the present disclosure is based on the difference in the shape of the particles. Accordingly, it is not necessarily required to use different materials for the first soft magnetic particles and the second soft magnetic particles. The dust core can be obtained less expensively by using the same material for the first soft magnetic particles and the second soft magnetic particles.

The dust core includes the mixed soft magnetic powder as a mixture of the first soft magnetic particles and the second soft magnetic particles having the foregoing predetermined properties, and can achieve both high magnetic permeability and high withstand voltage performance.

### First Soft Magnetic Particle

The first ellipsoidal soft magnetic particles 1 are particles having a smooth surface with a surface smoothness of 1.1 to 2.0. As shown in the FIGURE, the first soft magnetic particles 1 are rounded ellipsoidal particles with no sharp edge portions along the contour. In this way, insulation can be provided between the particles even when the particles are placed under the large load of pressure molding during dust core production.

A surface smoothness is a value obtained by dividing the actual surface area S1 of the particle by the surface area S2 of a spherical particle having the same volume-based diameter D as the particle, and a perfectly smooth surface with a surface roughness of 0. The particle surface becomes smoother as the surface smoothness approaches 1. The actual surface area S1 of the particle can be measured using, for example, a gas-adsorbing specific surface area meter. The surface area S2 is obtained by calculating the surface area of a sphere having the volume-based diameter D.

In the embodiment of the present disclosure, the method of production of the first soft magnetic particles is not particularly limited, as long as the first soft magnetic particles have a surface smoothness of 1.1 to 2.0. For example, a soft magnetic particle having smooth surface with a surface smoothness of 2.0 or less can be obtained by melting the surface of a soft magnetic particle at a temperature sufficiently higher than its melting point, followed by cooling.

By making the surface smoothness 2.0 or less, the frictional resistance between particles becomes smaller, and desirable fluidity can be obtained. Particularly, in the production of a dust core formed by mixing soft magnetic particles with a thermosetting resin, the amount of resin that does not contribute to the particle flow becomes reduced as smaller amounts of resin enter the fine irregularities in the particle surface, and the particles can be pressure molded with smaller amounts of the thermosetting resin, making it possible to increase the packing density of the soft magnetic particles.

The packing density increasing effect of a reduced surface smoothness becomes sufficient when the surface smoothness is 1.1 or more. A particle having an overly smooth surface with a surface smoothness of less than 1.1 is not preferable from a standpoint of manufacturing cost.

When 10% to 90% of the first soft magnetic particles are particles having a flattening of 1.2 or more, the particles with a flattening of 1.2 or more align themselves in a direction of particle flow during pressure molding, and the projected area as viewed in a direction of flowing particles becomes smaller than that of substantially spherical particles having a flattening of less than 1.2. This makes it possible to reduce fluid resistance. That is, the pressure of pressure molding can be reduced. A smaller fluid resistance enables molding of a more viscous mixture containing smaller amounts of resin and solvent in the production of a dust core formed by mixing the soft magnetic particles with a thermosetting resin, and the packing density of the soft magnetic particles can increase. This effect clearly occurs when at least 10% of the first soft magnetic particles have a flattening of 1.2 or more. However, the proportion of particles having a flattening of 1.2 or more is not necessarily required to exceed 90% because achieving flatness for all particles involves some cost (such as the cost of sieving), and the foregoing effect can still be obtained with such a proportion.

As used herein, flattening is a value obtained from three semi-axes of the ellipsoidal particle (half axes, for example, a semimajor axis, and two semiminor axes), specifically, a value obtained by dividing the maximum semi-axis (semimajor axis) by the minimum semi-axis (the smaller of the two semiminor axes). The particle shape becomes closer to a sphere as the flattening approaches 1.0. For the first soft magnetic particles, the flattening is preferably 1.2 or more and less than 3.0. For example, such a flattening range can be achieved by compressing a spherical particle, or by solidifying a molten particle or a molten particle surface while in flight at high speed. When using these methods, the flattening can be adjusted to any value by adjusting the compression load, or the traveling speed or the cooling rate of the molten particle.

### Second Soft Magnetic Particle

The second ellipsoidal soft magnetic particles 2 are particles having a rough, flat surface with a surface smoothness of 4.0 to 20.0, and a flattening of 3.0 to 15.0.

The method of production of the second soft magnetic particles is not particularly limited, as long as the surface smoothness is 4.0 to 20.0, and the flattening is 3.0 to 15.0. For example, the second ellipsoidal soft magnetic particles can be obtained by pulverizing a coarse soft magnetic body with a pulverizer such as a jet mill, a jaw crusher, a hammer crusher, a ball mill, a bead mill, a pin mill, a stamping mill, a planetary ball mill, a high-speed mixer, a grinder, and a cyclone mill. With a very short pulverization process, many of the product particles have a contour with straight lines. However, ellipsoidal particles with a rounded contour can be obtained by appropriately adjusting the pulverization time and other conditions. As with the case of the first soft magnetic particles, the ellipsoidal particles having a rounded contour of the second soft magnetic particles can provide insulation between particles even when placed under the large load of pressure molding during dust core production.

Particularly, in a dust core formed by mixing a thermosetting resin, the thermosetting resin enters the irregularities in the particle surface, and strongly binds to the particles when the particles have a rough surface with a surface smoothness of 4.0 or more. This makes it possible to reduce the space created when the resin and the particles detach from each other in the dust core, and to thereby increase the packing density of particles. It is, however, preferable that the surface smoothness be 20.0 or less because overly fine irregularities prevent entry of thermosetting resin, and remain unoccupied.

However, the particle fluidity deteriorates as the surface smoothness increases. Such fluidity deterioration can be reduced when the second soft magnetic particles are made flatter than the first soft magnetic particles, specifically, by making the flattening 3.0 or more, because it makes the particles align in a direction of particle flow, and reduces fluid resistance by making the projected area smaller. However, an overly flat shape, specifically, a flattening of more than 15.0 is not preferable because it makes the particles almost sheet-like, and causes the adjacent particles to bite into each other, and conduct electricity, thereby reducing a withstand voltage as described above in conjunction with the related art.

In order to ensure that the first soft magnetic particles and the second soft magnetic particles show their characteristics upon being mixed, it is preferable to mix the first soft magnetic particles and the second soft magnetic particles in a mixture ratio of 1:9 to 9:1.

When the particle size difference between the first soft magnetic particles and the second soft magnetic particles is overly large, the finer particles interfere with the particle flow during pressure molding, and a high particle packing density may not be obtained. It is therefore preferable that the first soft magnetic particles and the second soft magnetic particles have a ratio D1/D2 of 0.5 to 2.0, where D1 is the average particle size of the first soft magnetic particles, and D2 is the average particle size of the second soft magnetic particles.

### Dust Core Producing Method

An example of a method for producing the dust core is described below.

(1) First, a mixed soft magnetic powder is prepared that contains the first soft magnetic particles and the second soft magnetic particles. (2) The mixed soft magnetic powder is then mixed with a thermosetting resin, for example, an uncured silicone resin, and toluene, and the mixture is dried. Here, the mixture ratio of the silicone resin and toluene with respect to the mixed soft magnetic powder may be adjusted so that the viscosity of the mixture is, for example, 100 Pas. (3) After drying, the solid powder is re-pulverized with a ball mill, and molded under a molding pressure of, for example, 4 t/cm² using a core mold.

The dust core containing the mixed soft magnetic powder can be obtained in the manner described above.

The following describes Examples and Comparative Examples of the present disclosure. The present disclosure, however, is not limited to the following Examples and Comparative Examples.

In the Examples 1 to 3 and Comparative Examples 1 to 3 below, the dust core was produced using the same procedure, except that the soft magnetic particles shown in the table were used. In all Examples and Comparative Examples, an amorphous iron-base magnetic body containing at least 80 wt % of iron was used as the material of the first and the second soft magnetic particles.

A mixed soft magnetic powder containing the first and the second soft magnetic particles of Examples and Comparative Examples was mixed with an uncured silicone resin and toluene, and the mixture was dried. Here, the mixture ratio of the silicone resin and toluene with respect to the mixed soft magnetic powder was adjusted so that the viscosity of the mixture was 100 Pas.

After drying, the solid powder was re-pulverized with a ball mill, and molded under a molding pressure of 4 t/cm² to make an annular dust core, using a core mold.

This was followed by curing and annealing, in which the dust core was held at 250° C. for 12 hours. The dust core was then measured for magnetic permeability and withstand voltage. The results are presented in Table 1.

TABLE 1

| | First soft magnetic particle | | | | Second soft magnetic particle | | | | Mixture | | | |
|---|---|---|---|---|---|---|---|---|---|---|---|---|
| | Average | | | | Average | | | | ratio of | | | |
| | particle | | | | particle | | | | first and | | | Withstand |
| | size | Surface | | Particle | size | Surface | | Particle | second | Density | Relative | voltage |
| | (μm) | smoothness | Flattening | shape | (μm) | smoothness | Flattening | shape | particles | (g/cc) | permeability | (V/mm) |
| Ex. 1 | 4 | 1.3 | 1.4 | Ellipsoidal | 32 | 7.1 | 4.0 | Ellipsoidal | 5:5 | 5.3 | 23 | 262 |
| Ex. 2 | 28 | 1.4 | 1.5 | Ellipsoidal | 32 | 7.1 | 4.0 | Ellipsoidal | 1:10 | 5.2 | 22 | 266 |
| Ex. 3 | 28 | 1.4 | 1.5 | Ellipsoidal | 32 | 7.1 | 4.0 | Ellipsoidal | 5:5 | 5.8 | 26 | 280 |
| Com. | 28 | 1.4 | 1.5 | Ellipsoidal | 31 | 5.0 | 8.0 | Sheet-like | 5:5 | 5.1 | 19 | 50 |
| Ex. 1 | | | | | | | | | | | | |
| Com. | 26 | 5.5 | 1.4 | Ellipsoidal | 32 | 7.1 | 4.0 | Ellipsoidal | 5:5 | 4.5 | 14 | 226 |
| Ex. 2 | | | | | | | | | | | | |
| Com. | 28 | 1.4 | 1.5 | Ellipsoidal | 33 | 1.3 | 4.0 | Ellipsoidal | 5:5 | 4.2 | 13 | 238 |
| Ex. 3 | | | | | | | | | | | | |

As is clear from the results presented in the table, the dust cores of Examples 1 to 3 all had higher magnetic permeability and higher withstand voltage than the dust cores of Comparative Examples 1 to 3. The magnetic permeability and the withstand voltage were the highest in Example 3, in which the average particle size ratio of the first soft magnetic particles and the second soft magnetic particles was 0.9, and the mixture ratio of these particles was 5:5.

In contrast, the withstand voltage was considerably smaller in Comparative Example 1. In Comparative Examples 2 and 3, the packing density of the particles was low, and the magnetic permeability was small. The performance was accordingly not satisfactory in Comparative Examples.

It is to be noted that the present disclosure encompasses appropriate combinations of any of the various embodiments and/or Examples described above, and the effects of the foregoing embodiments and/or Examples can also be obtained in such combinations.

A dust core according to the present disclosure can achieve both high magnetic permeability and high withstand voltage performance.

What is claimed is:

1. A dust core comprising a mixed soft magnetic powder that contains:
a first soft magnetic particle of an ellipsoidal shape having a surface smoothness of 1.1 to 2.0; and
a second soft magnetic particle of an ellipsoidal shape having a surface smoothness of 4.0 to 20.0, and a flattening of 3.0 to 15.0.

2. The dust core according to claim 1, wherein the first soft magnetic particle represents particles of which 10% to 90% are particles having a flattening of 1.2 or more.

3. The dust core according to claim 1, wherein the first soft magnetic particle and the second soft magnetic particle have a mixture ratio of 1:9 to 9:1.

4. The dust core according to claim 1, wherein the first soft magnetic particle and the second soft magnetic particle have a ratio D1/D2 of 0.5 to 2.0, where D1 is an average particle size of the first soft magnetic particle, and D2 is an average particle size of the second soft magnetic particle.

5. The dust core according to claim 1, wherein the first soft magnetic particle and the second soft magnetic particle are made of same material.

6. A mixed soft magnetic powder comprising:
a first ellipsoidal soft magnetic particle having a surface smoothness of 1.1 to 2.0; and
a second ellipsoidal soft magnetic particle having a surface smoothness of 4.0 to 20.0, and a flattening of 3.0 to 15.0.
